(19) United States
(12) Patent Application Publication
(10) Pub. No.: US 2017/0220691 A1
(43) Pub. Date: Aug. 3, 2017

(54) System and Method for Automatically Identifying a Vehicle Model

(71) Applicant: Eliocity, Marquette Lez Lille (FR)

(72) Inventors: Camille Oulmane, Marcq en Baroeul (FR); Benjamin Dubois, La Madeleine (FR)

(21) Appl. No.: 15/421,789

(22) Filed: Feb. 1, 2017

(30) Foreign Application Priority Data
Feb. 2, 2016 (FR) 1650825

(51) Int. Cl. G06F 17/30; G07C 5/00

(52) U.S. Cl. CPC G06F 17/30867; G07C 5/008; G06F 17/30339

(57) ABSTRACT

A system for automatically identifying a model of a vehicle where the vehicle includes at least one network. The system includes an electronic device with means for acquiring data circulating on the or each network of the vehicle, the data including messages and message identification parameters; and a data processing module designed to generate a query requesting identification of the vehicle model; a data processing equipment item including storage means storing a look-up table between a list of identification parameters and a list of vehicle models, and an application having program instructions for computing a rate of similarity between a sample formed from the identification parameters contained in the query and corresponding to this network, and samples each formed from a set of parameters of the look-up table, and of identifying the corresponding vehicle model according to the result of the computation of the rate of similarity.

This application claims priority to French Patent Application No. 1650825 filed Feb. 2, 2016, the entire contents of which is incorporated herein by reference.

### BACKGROUND

The present invention relates generally to the field of the automatic identification of a vehicle model.

The present invention relates more particularly to a system and a method for automatically identifying a vehicle model, the system comprising an electronic device suitable for being arranged within the vehicle and being designed to be linked to at least one network of the vehicle. Such electronic devices make it possible, for example, to interface and exchange data with the network of the vehicle, typically to upload, to a remote server, data relating to the vehicle, such as, for example, physical parameters linked to the vehicle.

Systems for automatically identifying a vehicle model are known.

For example, some systems are based on databases containing registration plate numbers and/or vehicle owner name identifiers, with which vehicle models are associated. From these databases made available, for example, by service providers, such systems make it possible to automatically identify the vehicle model, by first retrieving the plate number or owner name information. However, these databases are limited in terms of number of references, all the more so as they are generally supplied by the relevant departments of a given state, and there is no analogous continental or worldwide department which would supply the information on a vehicle from its registration plate, whatever its country of origin.

Consequently, such a system is limited as to its use and has a relatively low number of identifiable vehicles compared to the total number of vehicles on the road. Moreover, the registration plate number or owner name information is not necessarily easy to retrieve, without the intervention of a user.

Systems for automatically identifying a vehicle model are also known which comprise an electronic device suitable for being arranged within the vehicle and designed to be linked to a network of the vehicle.

For example, a system is known that comprises an electronic device arranged within the vehicle and linked to a network of the vehicle, via a wired connection to an embedded onboard diagnostic (OBD) connector. The electronic device is adapted so as to obtain, via the network of the vehicle, a VIN (Vehicle Identifier Number) parameter stored in the onboard computer of the vehicle. This identification number VIN is a unique alpha numeric code which is given to each motor vehicle, and its retrieval by the electronic device thus allows for an automatic identification of the vehicle model.

However, this VIN parameter can be incorrect for certain vehicle models, which results in a reliability defect in the identification method. Moreover, this VIN parameter is accessible only via a particular data acquisition protocol, which is not widely circulated. This thus poses a problem of accessibility to this parameter for certain vehicle models.

### SUMMARY

The invention described herein below aims to remedy all or some of the drawbacks of the prior art and in particular to propose a system for automatically identifying a vehicle model that is compatible with a large number of vehicles currently registered, while at the same time offering improved identification accuracy and reliability.

To this end, the subject of the invention is a system for automatically identifying a model of a vehicle, the vehicle comprising one or more electronic control unit(s) connected to one another via at least one network of the vehicle, the system comprising an electronic device and a data processing equipment item, the electronic device being suitable for being arranged within the vehicle and being designed to be linked to at least one network of the vehicle,

the electronic device being linked to the data processing equipment item via a communication network and comprising means for communicating over the communication network; means for acquiring data circulating on the or each network of the vehicle, said data comprising messages and message identification parameters; and a data processing module linked to the communication means and to the data acquisition means, the data processing module being designed to generate a query requesting identification of the vehicle model, the query comprising at least one parameter identifying a message circulating on the or one of the network(s) of the vehicle;

the data processing equipment item comprising storage means and data processing means linked to the storage means, the storage means storing a look-up table between a list of message identification parameters circulating in vehicle networks and a list of associated vehicle models, the storage means also storing an application, the application being designed, when it is implemented by the data processing means after receiving a query requesting identification of the vehicle model, to identify, in the look-up table, a corresponding vehicle model;

in which the application comprises program instructions capable of computing, when the application is implemented by the data processing means, for the or each network of the vehicle, a rate of similarity between a sample formed from the identification parameters contained in the identification request query and corresponding to this network, and samples each formed from a set of parameters from the list of parameters of the look-up table, and of identifying the vehicle model according to the result of the computation of the rate of similarity.

By virtue of the fact that the electronic device, once arranged within a vehicle, is suitable for acquiring and for transmitting to the data processing equipment item messages and message identification parameters specific to the model of this particular vehicle, the identification system according to the invention is advantageously compatible with a large number of vehicles currently registered. In effect, as long as the message identification parameter-type information is entered in the look-up table for this vehicle model, the data processing equipment item will be able to identify the vehicle model concerned, after receiving the message identification parameters.

Furthermore, by virtue of the fact that the application comprises program instructions capable of computing a rate of similarity between a sample formed from the identification parameters contained in the identification request query and corresponding to this network, and samples each formed from a set of parameters of the list of parameters of the look-up table, and of identifying the vehicle model according to the result of the computation of the rate of similarity, the number of false positives is advantageously reduced, and the accuracy and the reliability of the identification are thus improved.

According to another aspect, another subject of the invention is a method for automatically identifying a model of a vehicle, the vehicle comprising one or more electronic control unit(s) connected to one another via at least one network of the vehicle, the method being implemented by an identification system as defined above, the electronic device being arranged within the vehicle and being linked to at least one network of the vehicle, the method comprising the following steps:

the acquisition, by the electronic device, of data circulating on the or each network of the vehicle, said data comprising messages and message identification parameters;

the generation, by the electronic device, of a query requesting identification of the vehicle model, the query comprising at least one parameter identifying a message circulating on the or one of the network(s) of the vehicle,

the transmission, by the electronic device, over the communication network to the data processing equipment item, of the query requesting identification of the vehicle model,

the reception, by the data processing equipment item, of the query requesting identification of the vehicle model,

the computation, by the application of the data processing equipment item, for the or each network of the vehicle, of a rate of similarity between a sample formed from the identification parameters contained in the identification request query and corresponding to this network, and samples each formed from a set of parameters of the list of parameters of the look-up table, and

the identification, by the application of the data processing equipment item in the look-up table, of the vehicle model, according to the result of the computation of the rate of similarity.

According to a particular technical feature of the invention, in the step of computation of a rate of similarity, the application applies, for the or each network of the vehicle, a coefficient of Sorensen-Dice type to each set formed from a sample contained in the identification request query and corresponding to this network, and a sample from the look-up table.

According to a particular technical feature of the invention, the data processing equipment item further comprises a means for storing signal configuration tables relating to vehicle models, each configuration table corresponding to a particular vehicle model, and the method further comprises a step of downloading, by the data processing means of the data processing equipment item, from the storage means, of the signal configuration table corresponding to the identified vehicle model.

According to a particular embodiment of the invention, on completion of the step of computation of a rate of similarity, an ordered sub-list of vehicle models is obtained, the vehicle models of the sub-list being models for which the computed rate of similarity is above a predetermined rate, the step of identification of the vehicle model being performed on the basis of said ordered sub-list of vehicle models.

According to particular features of this particular embodiment of the invention, the query requesting identification of the vehicle model further comprises at least one message circulating on the or one of the network(s) of the vehicle, and the method further comprises a step of determination, by the application of the data processing equipment item, for each vehicle model of the ordered sub-list of vehicle models, of a rate of useful signals contained in the messages of the or each sample of the identification request query, said rate of useful signals being determined from the signal configuration table associated with this vehicle model, the useful signals being the signals contained in said messages and appearing in said signal configuration table; and a step of computation, by the application of the data processing equipment item, for each vehicle model of the ordered sub-list of vehicle models, of an average value between the computed rate of similarity, associated with this vehicle model, and the rate of useful signals associated with this vehicle model.

This makes it possible to further improve the accuracy and the reliability of the identification.

According to another particular feature of this particular embodiment of the invention, in the step of identification of the vehicle model, the identified model is the model exhibiting the highest average value.

Advantageously, the method further comprises a step of transmission to the electronic device, by the data processing equipment item over the communication network, of said signal configuration table corresponding to the identified vehicle model, and a step of storage of said table, by the electronic device in a memory of the device.

These features advantageously make it possible to provide an automatic installation, in the electronic device, of data enabling the device to configure the analysis of the signals circulating within the or each network of the vehicle. This automatic installation is performed following a preliminary identification of the vehicle model according to the method as described above. Via this entirely automated identification and installation method, the electronic device arranged within a vehicle is thus in a position to be able to correctly interpret the signals circulating within the network of the vehicle to which it is linked, and to do so from the first connection of the device to the network of the vehicle.

According to a particular embodiment of the invention, in the step of identification of the vehicle model, the identified model is the model associated with the parameters of the list of parameters which exhibit the highest rate of similarity.

According to another aspect, another subject of the invention is a computer program product that can be downloaded from a communication network and/or stored in a memory of a data processing equipment item, said computer program product comprising program instructions forming the application of the identification system as described above, said program instructions being suitable for implementing the computation and identification steps of the method as described above when the program product is run in the data processing equipment item of the identification system.

### BRIEF DESCRIPTION OF THE DRAWINGS

Other features and advantages of the invention will emerge on reading the following description, given purely by way of example, and with reference to:

FIG. 1 which is a schematic representation of a system for automatically identifying a vehicle model according to the invention;

FIG. 2 which is a schematic representation of the system of FIG. 1 according to a particular embodiment of the invention;

FIG. 3 which is a flow diagram representing a method for automatically identifying a vehicle model according to the invention, implemented by the system of FIG. 1.

### DETAILED DESCRIPTION

Hereinafter in the description, “electronic device arranged within a vehicle and designed to be linked to at least one network of the vehicle” will be understood to mean any electronic device linked by wire or wirelessly to at least one network of the vehicle, and arranged in the vehicle; such as, for example, a telematics unit, a wireless telecommunication device such as a cell phone or a smartphone, a cellular navigation system, a portable computer or even a digital tablet, without this list being exhaustive.

Also, “firmware” is understood to be a set of instructions and data structures which are integrated in the computer hardware so that the latter are able to function.

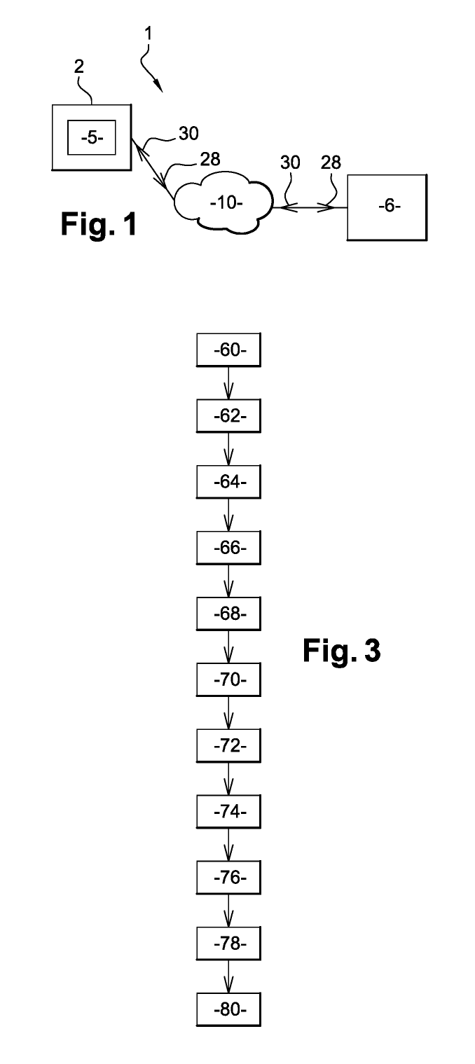

FIG. 1 shows a system 1 for automatically identifying a vehicle model. FIG. 1 also schematically shows a particular vehicle 2.

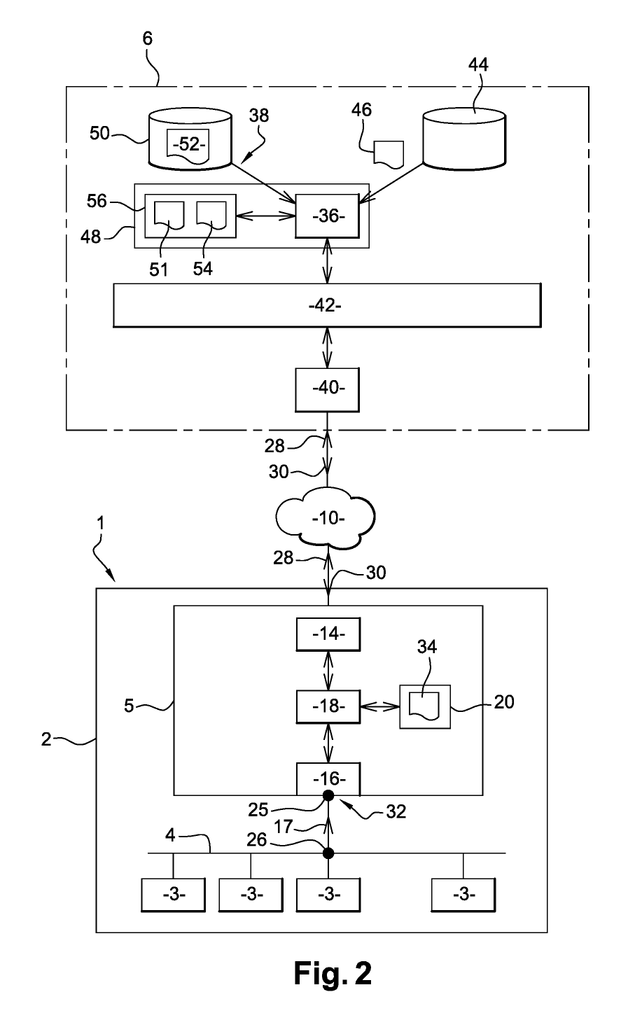

The vehicle 2 is, for example, a light vehicle of motor vehicle type, a heavy truck, a two-wheel vehicle, an autonomous vehicle, a flying vehicle or even a navigating vehicle, without this list being exhaustive. The vehicle 2 comprises several electronic control units 3, in this case four in the illustrative example of FIG. 2, connected to one another via at least one network 4 of the vehicle 2. In the particular exemplary embodiment of FIG. 2, the vehicle 2 comprises only a single vehicle network 4. In a variant not represented, the vehicle 2 comprises several vehicle networks 4, corresponding to several distinct types of signals circulating within the vehicle 2. The electronic control units 3 are configured to control different subsystems of the vehicle 2. The network 4 is typically a network conforming to a data communication protocol of point-to-point type. The vehicle network 4 is for example a CAN (Controller Area Network) bus.

To return to FIG. 1, the system 1 comprises an electronic device 5 and a data processing equipment item 6.

The electronic device 5 is arranged within the vehicle 2 and is linked to at least one network 4 of the vehicle 2, to interface and exchange data with this network 4, as represented in FIG. 2. The electronic device 5 is also linked to the data processing equipment item 6 via a communication network 10. The electronic device 5 comprises means 14 for communicating over the communication network 10, means 16 for acquiring data 17 circulating on the or each network 4 of the vehicle 2, and a data processing module 18. Preferably, as illustrated in FIG. 2, the electronic device 5 further comprises a memory 20 linked to the data processing module 18.

As illustrated in FIG. 2, the electronic device 5 is for example an autonomous unit in the form of a telematics device provided with a connector 25, linked by wire to a connector 26 of the vehicle 2. Such a connector 26, linked to at least one network 4 of the vehicle 2, is for example a connector of OBD (On-Board Diagnostic) type. As a variant, the electronic device 5 can be incorporated in a pre-existing element of the vehicle 2 within which it is arranged, such as a dashboard for example, and thus be linked to at least one network 4 of the vehicle 2.

The communication network 10 is provided with a private or extended communication infrastructure allowing the connection, or access, to communication equipment items of server type and/or databases and/or electronic communication devices. Conventionally, the communication infrastructure forms a wireless network, or a network comprising a wireless portion and a wired portion. According to a particular exemplary embodiment, the communication network 10 is designed as a cellular network of GPRS (General Packet Radio Service) or even UMTS (Universal Mobile Telecommunications System) type or even as an area network. As a variant, the communication network 10 can be designed as a network of internet type, for example comprising a network portion conforming to the GPRS standard or to the UMTS standard.

The means 14 for communicating over the communication network 10 are capable of transmitting messages 28 over the communication network 10 to the data processing equipment item 6, notably messages 28 of query type as will be detailed hereinbelow. Preferably, the communication means 14 are also capable of receiving messages 30 from the data processing equipment item 6, via the communication network 10. The communication means 14 for example comprise a transmitting-receiver of data over a cellular communication network, such as an antenna.

The means 16 for acquiring data 17 comprise, for example, a network interface 32.

The network interface 32 is provided with electrical and electronic levels and protocols required to interact with the or each vehicle network 4, and in particular to retrieve data 17 circulating on the or each vehicle network 4. The network interface 32 for example takes the form of a wireless antenna, or even, in the exemplary embodiment of FIG. 2, the form of a connector 25 intended to be linked to at least one vehicle network 4 by wire.

The data 17 circulating on the or each network 4 of the vehicle 2 comprise messages and parameters identifying these messages. Each message contains one or more signals. Each signal comprises, for example, data measuring physical parameters relating to the vehicle 2, typically parameters such as the speed of the vehicle, the number of revolutions per minute, or even parameters indicative of the data rate within the network 4, of the state of the airbags, or of the state of engagement of the seatbelts, without this list being exhaustive. The messages for example conform to the CAN (Controller Area Network) protocol. Each parameter identifying a message is for example formed from a pair containing a datum indicative of the size of the message in bytes, associated with an identifier of the message.

The data processing module 18 is linked to the communication means 14, to the means 16 for acquiring data 17, and to the memory 20. The data processing module 18 is designed to generate a query 28 requesting identification of the vehicle model 2. In particular, the data processing module 18 is designed to generate an identification request query 28 upon the first connection of the electronic device 5 to the network 4 of the vehicle 2, as will be detailed hereinbelow. The query 28 comprises at least one parameter identifying a message contained in data 17 acquired by the data acquisition means 16. In other words, the query 28 comprises at least one parameter identifying a message circulating on the or one of the network(s) 4 of the vehicle 2. In a particular exemplary embodiment of the invention, the query 28 also comprises at least one message contained in data 17 acquired by the data acquisition means 16. The data processing module 18 is for example formed of a processor.

The memory 20 is for example a reprogrammable non-volatile memory, typically a flash memory. Preferably, the memory 20 stores a firmware 34 which, when executed by the data processing module 18, supplies a set of functionalities to the electronic device 5 enabling the latter to function. For example, the firmware 34 is designed, when implemented by the data processing module 18, to participate in generating the query 28 for requesting identification of the vehicle model 2.

As represented in FIG. 2, the data processing equipment item 6 comprises data processing means 36 and storage means 38. Preferably, the data processing equipment item 6 further comprises means 40 for communicating over the communication network 10, a central bus 42, and a means 44 for storing signal configuration tables 46 relating to vehicle models. In the particular exemplary embodiment of FIG. 2, the data processing equipment item 6 further comprises a server 48 and a database 50.

Preferably, the server 48 sets out a programming interface 51. The programming interface 51 is for example an interface making it possible to remotely update the firmware 34 in the electronic device 5. The programming interface 51 is for example stored in a memory 56 of the server 48. The memory 56 is for example a reprogrammable non-volatile memory.

The data processing means 36 are for example formed by a processor. In the particular exemplary embodiment of FIG. 2, the data processing means 36 are arranged within the server 48 and form a processor of this server 48.

The storage means 38 are linked to the data processing means 36. The storage means 38 store a look-up table 52 between a list of parameters identifying messages circulating in vehicle networks, and a list of associated vehicle models. In the look-up table 52, each vehicle model has one or more samples associated with it, each sample being formed from a set of message identification parameters corresponding to a particular network of the vehicle according to this model. The storage means 38 also store an application 54. In the particular exemplary embodiment of FIG. 2, the storage means 38 comprise the database 50, and the memory 56 of the server 48. The database 50 stores the look-up table 52. The memory 56 stores the application 54.

The application 54 is designed, when implemented by the data processing means 36 after the reception of a query 28 requesting identification of the vehicle model 2, to identify, in the look-up table 52, a corresponding vehicle model. More specifically, the application 54 comprises program instructions capable of computing, when the application 54 is implemented by the data processing means 36, for the or each network 4 of the vehicle 2, a rate of similarity between a sample formed from the identification parameters contained in the identification request query 28 and corresponding to this network 4, and each sample of the look-up table 52, and of identifying the vehicle model according to the result of the computation of the rate of similarity.

This makes it possible to advantageously reduce the number of false positives in the identification and thus improve the accuracy and the reliability of the identification.

Preferably, the program instructions of the application 54 are capable of applying, for the or each network 4 of the vehicle 2, a coefficient of Sorensen-Dice type to each set formed from a sample contained in the identification request query 28 and corresponding to this network 4, and from a sample of the look-up table 52. The computation of an SD coefficient of Sorensen-Dice type on two input samples A and B which take the form of finite sets is given by the following mathematical formula:

$$SD ( A , B ) = \frac{2. \vert A ⋂ B \vert}{\vert A \vert + \vert B \vert}$$

where |A| is the number of elements of A, and |B| is the number of elements of B. In this particular case, according to the invention, the number of elements of a sample contained in the identification request query 28 is the number of distinct identification parameters present in this sample. Similarly, the number of elements of a sample of the look-up table 52 is the number of distinct identification parameters present in this sample.

Even more preferably, in the particular exemplary embodiment according to which the vehicle 2 comprises several vehicle networks 4, the program instructions of the application 54 are capable of computing, for each vehicle model of the look-up table 52, an average value between the different coefficients of Sorensen-Dice type previously computed for each network 4 of the vehicle 2.

More preferably, in the particular exemplary embodiment according to which the identification request query 28 also comprises at least one message, the program instructions of the application 54 are capable of determining, for each vehicle model of a sub-list of vehicle models of the look-up table 52, a rate of useful signals contained in the messages of the or each sample of the query 28, as will be detailed hereinbelow. “Useful signals” should be understood to mean the signals contained in these messages and appearing in the signal configuration table 46 associated with this vehicle model. More specifically, the program instructions of the application 54 are capable of comparing, for each vehicle model of this sub-list and from the signal configuration table 46 associated with this vehicle model, the signals contained in this table to the signals contained in the messages of the or each sample of the query 28, and of deducing therefrom the rate of useful signals associated with this vehicle model.

More preferably, in the particular exemplary embodiment according to which the identification request query 28 further comprises at least one message, the program instructions of the application 54 are capable of computing, for each vehicle model of a sub-list of vehicle models of the look-up table 52, an average value between the computed rate of similarity, or the average of the computed rates of similarity if appropriate, associated with this model, and the rate of useful signals associated with this model.

The means 40 for communicating over the communication network 10 are capable of receiving messages 28 from the electronic device 5, via the communication network 10. Preferably, the communication means 40 are also capable of transmitting messages 30 over the communication network 10 to the electronic device 5. The communication means 40 comprise, for example, a TCP (Transmission Control Protocol) server.

The central bus 42 is linked to the data processing means 36 and to the communication means 40. The central bus 42 is an intermediate program module capable of ensuring the communication between the components of the data processing equipment item 6, via formally defined messages. The central bus 42 thus makes it possible to transmit the messages within the data processing equipment item 6, according to an asynchronous transmission mode. The presence of a central bus 42 improves the absorption of load peaks, while making it possible to replay messages if necessary, and thus makes the system more flexible, rapid, robust and tolerant to failures. Preferably, the central bus 42 is configured to transiently maintain the data that it transmits, until the latter have been processed by one of the components of the equipment item 6 or by a third-party system. This advantageously makes it possible to improve the failure-tolerance of the system.

The means 44 for storing signal configuration tables 46 is linked to the data processing means 36. Each configuration table 46 corresponds to a particular vehicle model and makes it possible for an electronic device arranged in a vehicle of this model and linked to a network of this vehicle to be able to configure the analysis of the signals circulating within this network, as will be described hereinbelow. The storage means 44 is for example formed by a database.

The method for identifying the vehicle model 2, implemented by the identification system 1 of FIG. 1, will now be described with reference to FIGS. 2 and 3.

It is assumed that initially the electronic device 5 is connected to the network 4 of the vehicle 2. In the particular exemplary embodiment of FIG. 2, the connector 25 of the electronic device 5 is, for this purpose, linked by a wire to the connector 26 of the vehicle 2. In a variant not represented, the vehicle 2 comprises several networks 4 and the electronic device 5 is connected to each of the networks 4.

The method comprises an initial step 60 during which the electronic device 5 acquires data 17 circulating on the or each network 4 of the vehicle 2. More specifically, the data acquisition means 16 of the electronic device 5 acquire such data 17 circulating on the or each network 4. The initial step 60 can for example be implemented upon the first connection of the electronic device 5 to at least one network 4 of the vehicle 2. As a variant, the initial step 60 can be implemented following a request from the programming interface 51 to the electronic device 5, or even following a detection of the or one of the network(s) 4 of the vehicle by the electronic device 5. On completion of this initial step 60, the data acquisition means 16 transmit the data 17 acquired to the data processing module 18.

During a following step 62, the electronic device 5 generates a query 28 requesting identification of the vehicle model 2. More specifically, the data processing module 18 of the electronic device implements the firmware 34 and generates the query 28 with the firmware 34. The query 28 requesting identification of the vehicle model 2 comprises at least one parameter identifying a message belonging to the data 17 acquired and circulating on the or one of the network(s) 4 of the vehicle 2. On completion of the step 62, the data processing module 18 transmits the query 28 to the communication means 14.

During a following step 64, the electronic device 5 transmits, over the communication network 10 to the data processing equipment item 6, the query 28 requesting identification of the vehicle model 2. More specifically, the communication means 14 of the electronic device 5 transmit the query 28 over the communication network 10 to the data processing equipment item 6.

During a following step 66, the data processing equipment item 6 receives the query 28 requesting identification of the vehicle model 2. More specifically, the communication means 40 of the data processing equipment item 6 receive the query 28. On completion of the step 66, the communication means 40 transmit the query to the central bus 42, which in turn transmits it to the data processing means 36.

During a following step 68, the data processing means 36 of the data processing equipment item 6 implement the application 54. The program instructions of the application 54 then compute, for the or each network 4 of the vehicle 2, a rate of similarity between a sample formed from the identification parameters contained in the identification request query 28 and corresponding to this network 4, and each sample of the look-up table 52. Preferably, during this computation step 68, the program instructions of the application 54 apply, for the or each network 4 of the vehicle 2, a coefficient of Sorensen-Dice type to each set formed from a sample contained in the identification request query 28 and corresponding to this network 4, and from a sample of the look-up table 52. In the particular exemplary embodiment according to which the vehicle 2 comprises several networks 4, on completion of this computation step 68, the program instructions of the application 54 compute, for each vehicle model of the look-up table 52, an average value between the different coefficients of Sorensen-Dice type previously computed for each network 4 of the vehicle 2.

According to a preferential exemplary embodiment of the invention, on completion of this computation step 68, an ordered sub-list of vehicle models is obtained. The vehicle models of the sub-list are models for which the computed rate of similarity, or the average of the computed rates of similarity if appropriate, is above a predetermined rate.

More preferably, in the particular exemplary embodiment according to which the query 28 also comprises at least one message and an ordered sub-list of vehicle models is obtained on completion of the computation step 68, the method comprises a following step 70 during which the data processing means 36 of the data processing equipment item 6 implement the application 54. The program instructions of the application 54 then determine, for each vehicle model of the ordered sub-list obtained on completion of the computation step 68, a rate of useful signals contained in the messages of the or each sample of the query 28. More specifically, the program instructions of the application 54 compare, for each vehicle model of the ordered sub-list and from the signal configuration table 46 associated with this vehicle model, the signals contained in this table to the signals contained in the messages of the or each sample of the query 28, and deduce therefrom the rate of useful signals associated with this vehicle model.

More preferably, in the particular exemplary embodiment according to which the query 28 also comprises at least one message and an ordered sub-list of vehicle models is obtained on completion of the computation step 68, the method comprises a following step 72 during which the data processing means 36 of the data processing equipment item 6 implement the application 54. The program instructions of the application 54 then compute, for each vehicle model of the ordered sub-list obtained on completion of the computation step 68, an average value between the computed rate of similarity, or the average of the computed rates of similarity if appropriate, associated with this model, and the rate of useful signals associated with this model.

During a following step 74, the data processing means 36 of the data processing equipment item 6 implement the application 54. The program instructions of the application 54 then identify the vehicle model 2 according to the result of the computation of the rate of similarity performed in the step 68.

More specifically, in a particular exemplary embodiment according to which the method does not comprise the determination and computation steps 70, 72, the vehicle model identified during the step 74 is the model associated with the parameters of the list of parameters which exhibit the highest rate of similarity.

In a variant, in the preferential exemplary embodiment according to which the method comprises the determination and computation steps 70, 72, and according to which an ordered sub-list of vehicle models is obtained on completion of the computation step 68, the step 74 of identification of the vehicle model is performed on the basis of this ordered sub-list of vehicle models. More specifically, according to this preferential exemplary embodiment, the vehicle identified model during the step 74 is the model having the highest average value, this average value being the average value computed during the step 72.

Preferably, in the particular exemplary embodiment according to which the data processing equipment item 6 comprises a means 44 for storing signal configuration tables 46, the method comprises a following step 76 during which the data processing means 36 of the equipment item 6 download, from the storage means 44, the signal configuration table 46 corresponding to the vehicle model identified during the identification step 74.

More preferably, in the particular exemplary embodiment according to which the data processing equipment item 6 comprises a means 44 for storing signal configuration tables 46, the method comprises a following step 78 during which the data processing equipment item 6 transmits to the electronic device 5 the signal configuration table 46 corresponding to the vehicle model identified during the identification step 74, via the communication network 10. More specifically, the data processing means 36 of the equipment item 6 incorporate the signal configuration table 46 corresponding to the vehicle model identified in one or more message(s) 30, then transmits this or these message(s) to the electronic device 5, via the communication means 40 and the communication network 10.

More preferably, in the particular exemplary embodiment according to which the data processing equipment item 6 comprises a means 44 for storing signal configuration tables 46, the method comprises a final step 80 during which the electronic device 5 stores, in its memory 20, the signal configuration table 46 corresponding to the vehicle model identified during the identification step 74. The electronic device 5 thus stores in its memory 20 the table 46 enabling it to configure the analysis of the signals circulating within the or each network 4 of the vehicle 2.

The system for automatically identifying a vehicle model according to the invention offers a number of advantages:

the system advantageously adapts to all the vehicles equipped with at least one vehicle network linking one or more electronic control unit(s), in other words to a very large number of vehicles currently registered;

the system does not at any time require intervention from a user;
by virtue of the computation of a rate of similarity, the system offers enhanced identification accuracy and reliability.

In the claims, the word “comprising” does not exclude other elements.

1. A system for automatically identifying a model of a vehicle, the vehicle comprising one or more electronic control unit(s) connected to one another via at least one network of the vehicle, the system comprising:
an electronic device and a data processing equipment item, the electronic device arranged within the vehicle and linked to at least one network of the vehicle;
the electronic device being linked to the data processing equipment item via a communication network and comprising:
means for communicating over the communication network;
means for acquiring data circulating on the or each network of the vehicle, the data comprising messages and message identification parameters; and
a data processing module linked to the communication means and to the data acquisition means, the data processing module being designed to generate a query requesting identification of the vehicle model, the query comprising at least one parameter identifying a message circulating on the or one of the vehicle network(s) of the vehicle;
the data processing equipment item comprising storage means and data processing means linked to the storage means, the storage means storing a look-up table between a list of parameters identifying messages circulating in vehicle networks and a list of associated vehicle models, the storage means also storing an application, the application being designed, when it is implemented by the data processing means after receiving a query requesting identification of the vehicle model, to identify, in the look-up table, a corresponding vehicle model;
wherein the application comprises program instructions capable of computing, when the application is implemented by the data processing means, for the or each network of the vehicle, a rate of similarity between a sample formed from the identification parameters contained in the identification request query and corresponding to this network, and samples each formed from a set of parameters from the list of parameters of the look-up table, and of identifying the vehicle model according to the result of the computation of the rate of similarity.

2. A method for automatically identifying a model of a vehicle that includes one or more electronic control unit(s) connected to one another via at least one network of the vehicle, the method being implemented by an identification system according to claim 1, the electronic device being arranged within the vehicle and being linked to at least one network of the vehicle, the method comprising the following steps:
acquiring, by the electronic device, data circulating on the or each network of the vehicle, the data comprising messages and message identification parameters;
generating, by the electronic device, a query requesting identification of the vehicle model, the query comprising at least one parameter identifying a message circulating on the or one of the network(s) of the vehicle,
transmitting, by the electronic device, over the communication network to the data processing equipment item, the query requesting identification of the vehicle model,
receiving, by the data processing equipment item, the query requesting identification of the vehicle model,
computing, by the application of the data processing equipment item, for the or each network of the vehicle, a rate of similarity between a sample formed from the identification parameters contained in the identification request query and corresponding to this network, and samples each formed from a set of parameters of the list of parameters of the look-up table,
identifying, by the application of the data processing equipment item in the look-up table, the vehicle model, according to the result of the computation of the rate of similarity.

3. The method according to claim 2, wherein when the computing of the rate of similarity, the application applies, for the or each network of the vehicle, a coefficient of Sorensen-Dice type to each set formed from a sample contained in the identification request query and corresponding to this network, and a sample from the look-up table.

4. The method according to claim 2, wherein the data processing equipment item further comprises a means for storing signal configuration tables relating to vehicle models, each configuration table corresponding to a particular vehicle model, and the method further comprises downloading, by the data processing means of the data processing equipment item, from the storage means, the signal configuration table corresponding to the identified vehicle model.

5. The method according to claim 4, wherein, on completion of the computation of a rate of similarity, an ordered sub-list of vehicle models is obtained, the vehicle models of the sub-list being models for which the computed rate of similarity is above a predetermined rate, the step of identification of the vehicle model being performed on a basis of the ordered sub-list of vehicle models.

6. The method according to claim 5, wherein the query requesting identification of the vehicle model further comprises at least one message circulating on the or one of the network(s) of the vehicle, and the method further comprises:
determining, by the application of the data processing equipment item, for each vehicle model of the ordered sub-list of vehicle models, a rate of useful signals contained in the messages of the or of each sample of the identification request query, the rate of useful signals being determined from the signal configuration table associated with this vehicle model, the useful signals being the signals contained in the messages and appearing in the signal configuration table; and
computing, by the application of the data processing equipment item, for each vehicle model of the ordered sub-list of vehicle models, an average value between the computed rate of similarity associated with this vehicle model, and the rate of useful signals associated with this vehicle model.

7. The method according to claim 6, wherein in the step of identifying the vehicle model, the identified model is the model exhibiting the highest average value.

8. The according to claim 4, further comprising transmitting to the electronic device, by the data processing equipment item over the communication network, the signal configuration table corresponding to the identified vehicle model, and storing the table, by the electronic device in a memory of the device.

9. The method according to claim 2, wherein in the step of identifying the vehicle model, the identified model is the model associated with the parameters of the list of parameters that exhibit the highest rate of similarity.
